(19) United States
(12) Patent Application Publication
(10) Pub. No.: US 2017/0044366 A1
(43) Pub. Date: Feb. 16, 2017

(54) THERMOPLASTIC COMPOSITION

(71) Applicant: Valeo Vision, Bobigny Cedex (FR)

(72) Inventor: Laurent Luc Barre, Hochfelden (FR)

(21) Appl. No.: 15/306,208

(22) PCT Filed: Apr. 16, 2015
(86) PCT No.: PCT/EP2015/058302

§ 371 Date: Oct. 24, 2016

(30) Foreign Application Priority Data
Apr. 28, 2014 (FR) 1453800

(51) Int. Cl. C08L 69/00; B29C 45/00

(52) U.S. Cl. CPC C08L 69/00; B29C 45/0025; B29C 45/0001; C08L 2205/06; C08L 2205/025; B29K 2069/00

(57) ABSTRACT

An injectable or extrudable polymer composition comprising from 90 to 99.9% by weight of a first polymer, and from 0.1 to 10% by weight of a lubricating compound obtained by partial depolymerization of a polymer, the percentages being expressed with respect to the total weight of the composition, and the polymer from which the lubricating compound is obtained being the first polymer or a polymer of the same nature as the first polymer. The invention also relates to a process for the manufacture of the composition and to the use of the latter in the manufacture of parts, in particular of motor vehicle parts.

The present invention relates to the field of injection of plastics, in particular for manufacturing a plastic part for an optical device for a motor vehicle.

It is known to manufacture plastic parts by injection. For example, a unit for the injection of plastic comprising a barrel comprising an inlet and an outlet for material and also a reciprocating screw housed in the barrel is known. This screw, of endless type, is used to blend and convey the plastic from the inlet toward the outlet of the unit and then to inject the material into a mold.

The plastic is generally introduced into the injection unit in the form of plastic granules. Granules is understood to mean elements, the size of which is greater than approximately 0.5 mm, preferably greater than 1 mm, more preferably still equal to approximately 2 mm, and generally does not exceed 1 cm.

Additives, such as dyes, plasticizers, and the like, can also be introduced into this unit.

In point of fact, increasingly, it is desired to reduce the amount of plastic used to produce a given part, in order to reduce the production costs and the weight of the part, while retaining good mechanical properties of the part.

However, when it is desired to reduce the thickness of the walls of the part, it is necessary for the cavities of the molds into which the material is injected to be thinner. In point of fact, these thinner cavities offer more resistance to the flow of the molten plastic. This will require greater injection pressures, which necessitates more powerful and often bulkier injection units.

In order to avoid increasing the pressure for a given injection unit, it is possible to reduce the viscosity of the plastic injected. However, this decrease in viscosity during the injection often takes place to the detriment of the mechanical properties of the part once cooled.

It is possible to envisage carrying out a multipoint injection of the plastic into the mold without modifying the viscosity of the plastic injected. However, this solution can result in the formation of “weld” lines which can weaken the part. Furthermore, these weld lines are often esthetically unacceptable.

It is also possible to envisage adding additives in order to decrease the viscosity of the material injected. However, the presence of additives not only increases the manufacturing costs but also exhibits negative effects on the mechanical properties of the materials. Furthermore, the addition of additives presents numerous problems of homogenization during the mixing with the plastic preceding the injection.

Another method for fluidifying the material is to cause it to foam. Here again, this method has limits in terms of appearance and of physical properties of the part obtained, in particular its delamination.

It is an aim in particular of the invention to provide a polymer composition, in particular an injectable or extrudable composition and in particular a thermoplastic polymer composition, which makes it possible in particular to produce a part, the thickness of the wall of which is reduced and which retains good mechanical properties.

To this end, the subject matter of the invention is an injectable or extrudable composition, more particularly a composition which can be injected into a mold, comprising:
from 90 to 99.9% by weight of a first polymer, and
from 0.1 to 10% by weight of a lubricating compound obtained by partial depolymerization of a polymer,

the percentages being expressed with respect to the total weight of said composition, and the polymer from which the lubricating compound is obtained being said first polymer or a polymer of the same nature as said first polymer.

This is because the use of a lubricating compound obtained from the polymer constituting the majority of the material makes it possible to obtain finer molded or extruded parts while retaining to a certain extent or while preventing an excessively great deterioration in characteristics associated with the use of pure material, such as, for example, a better resistance to yellowing.

Thus, it is advantageous for the lubricating compound to be obtained from a product which is the same as that which will constitute the predominant material of the injectable or extrudable composition. As this material is generally a polymer, the precise molecular size and structure of the components of this material can vary. It is thus recommended to use, for the manufacture of the lubricating compound, a polymer exhibiting the same structural or physical characteristics or similar or close characteristics, that is to say characteristics of the same nature. “Structural characteristic” is understood in particular to mean the nature of the polymer unit in question, the degree of polymerization and/or the distribution in weight or in length of these chains. “Physical characteristic” is understood to mean, for example, one or more characteristics such as the density, the flowability, the molding shrinkage, the flow, the transverse flow, water absorption; mechanical characteristics, such as the tensile and flexural moduli; impact, hardness, thermal, electrical, optical, flammability and corrosion characteristics, and the like.

It is thus possible to envisage using, in order to obtain the compound according to the invention, a polymer originating from the same manufacturer, indeed from one and the same batch, as that which will be used subsequently in the composition according to the invention.

However, this degree of similarity is not required to carry out the invention in practice. Thus, a reduced degree of similarity is sufficient to acceptably carry out in practice. For example, the use of a polymer with the same general chemical formula (for example a polycarbonate) is sufficient to obtain the desired technical effects.

According to a preferred embodiment, the first polymer is a plastic, advantageously a thermoplastic.

The first polymer can advantageously be chosen from the group consisting of polycarbonate (PC), polycarbonate/acrylonitrile butadiene styrene (PC-ABS), polyetherimide (PEI), high-heat polycarbonate (HH-PC) and their mixtures. Preferably, the first polymer is polycarbonate or high-heat polycarbonate. These polymers are generally chosen from the types commonly used for the manufacture of molded or extruded plastic parts used in the motor industry.

Preferably, the lubricating compound is a hydrolysate obtained by hydrolysis of the polymer, this hydrolysis making possible the depolymerization of the polymer. This hydrolysis can advantageously be carried out by bringing together the polymer and a mixture of water and alcohol (for example ethanol), more particularly a 50/50 v/v mixture of these compounds. This mixture can then be heated. It is also recommended to carry out the hydrolysis reaction under pressure, so as to retain the liquid state of the reaction medium.

The reaction conditions and in particular the pressure, temperature and duration conditions of the reaction depend in part on the polymer hydrolyzed and on the degree of hydrolysis desired. For a polymer of polycarbonate type (of or not of high density) exhibiting an Mn (g/mol) of approximately 22 000±10% and an Mw (g/mol) of approximately 42 500±5% (which are measured by UV detection), a temperature of approximately 260° C.±10° C. at a pressure of approximately 50 bar±5 bar and a reaction time of 10 to 100 minutes (min), preferably of 15 to 80 min, in particular of 15 to 25 min, may be sufficient.

Preferably, the degree of hydrolysis is such that the number-average and/or weight-average molar mass of the hydrolysate is reduced by a factor ranging from 3 to 20 with respect to that of the first polymer. This number-average and/or weight-average molar mass can be reduced by a factor ranging from 5 to 15, more particularly by a factor ranging from 8 to 12.

Preferably, the composition according to the invention exhibits an improved flowability, more particularly a flowability which is improved with respect to the flowability of the first polymer. This improvement is, for example, measured by increasing the MFI. Thus, according to a preferred aspect of the invention, the flowability of a composition according to the invention is doubled with respect to the flowability of the first polymer.

According to a preferred embodiment of the invention, the composition comprises:
from 97 to 99%, for example 98%, by weight of first polymer, and
from 1 to 3%, for example 2%, by weight of lubricating compound,

the percentages being expressed with respect to the total weight of said composition.

The composition according to the invention can advantageously be provided in fractionated solid form, such as granules or powder or a mixture of these compounds. Preferably, the lubricating compound and the first polymer are combined, for example by extrusion, to form granules which are ready to be used in the manufacture of parts, for example molded parts.

According to a preferred embodiment, the composition according to the invention comprises only a limited number of constituents. Thus, it may comprise, in addition to the lubricating compound and the first polymer, only a reinforcing filler, for example talc or glass fibers. The reinforcer makes it possible to enhance the mechanical properties of the molded part. According to an alternative form of this embodiment, the composition can also consist only of the lubricating compound and the first polymer.

Alternatively, the composition can also comprise such a reinforcing filler in combination with other compounds.

Another subject matter of the invention is a process for the preparation of a composition as described above, said process comprising the following stages:
obtaining a lubricating compound by depolymerization of a polymer,
combining from 10 to 0.1% by weight of said lubricating compound with from 90 to 99.1% by weight of said polymer or of a polymer of the same nature,

the percentages being expressed with respect to the total weight of said composition.

The polymer and the lubricating compound can be, independently of one another, in the fractionated solid form (powder form, compacted granules form) or resin form.

The combining stage can advantageously comprise an extrusion stage, preferably a stage of extrusion of this combination. It is thus possible to obtain a solid composition according to the invention in the solid form of granules or powder.

The process according to the invention can advantageously comprise the stages described above in connection with the composition according to the invention.

Another subject matter according to the invention is an injectable or extrudable composition capable of being obtained by the process according to the invention.

Another subject matter of the invention is the use of a composition according to the invention as described above for the injection molding of a part, preferably of a thin-walled part. “Thin-walled” is understood to mean for example, parts, the thickness of which is less than 2 mm.

Preferably, said part is a component of a motor vehicle lighting and/or signaling device.

Thus, another subject matter of the invention is a molded part obtained by injection into a mold of a composition and/or according to a process as defined above.

According to optional characteristics of the invention, corresponding to possible embodiments, the part:
is a thin-walled part;
is a motor vehicle part;
is a motor vehicle luminous and/or lighting and/or signaling device part; and/or
is a headlamp shield or a headlamp housing.

Another subject matter of the invention is a luminous and/or lighting and/or signaling device, in particular a headlamp, comprising a part according to the present invention.

Another subject matter according to the invention is a motor vehicle comprising a lighting and/or signaling part and/or device according to the present invention.

In order to produce such parts according to the invention, use is made of an injection process, this process also being a subject matter of the invention. This process uses an injection unit comprising a material inlet, an outlet for material toward a mold and means for conveying the material between the material inlet and outlet (for example the flights of an endless screw) and comprises the following stages:
the composition according to the invention is introduced into the inlet of the injection unit;
the mixture is conveyed in the injection unit, preferably while gradually raising the temperature of the mixture during its displacement in the injection unit;
the mixture is injected, through the outlet of the injection unit, into a mold.

This process can comprise a preliminary stage where, before the stage of introduction of the composition, the mixture comprising the composition according to the invention is prepared.

Thus, the process of the invention makes it possible to manufacture, in a standard injection unit, a plastic part of low thickness, the mechanical properties of which after injection and cooling are not degraded or only slightly degraded and which exhibits a homogeneous surface appearance.

A nonlimiting embodiment of the invention has been used in the following examples:

### STAGE 1: CONTROLLED DEPOLYMERIZATION OF A POLYMER (RESIN) FRACTION BY HYDROLYSIS

One of the polymers used is a gray-colored polycarbonate sold by Bayer MaterialScience under the name Makrolon® 2405, the specific technical characteristics of which are described in the UL IDES data sheet (certification organization, the address of which is Washington, D.C. Government Services 1850 M. St. N.W., Suite 1000 Washington, D.C. 20036-5833 U.S.A.) dated Sep. 13, 2013.

Another polymer used is a high-heat polycarbonate sold by Apec® 1895, the specific technical characteristics of which are described in the UL IDES data sheet dated Sep. 17, 2013.

Other polymers can obviously be used according to the same procedure.

### Equipment Used

1-litre graduated measuring cylinder
1 5-litre polypropylene plastic bucket, 3 2-litre PP buckets
Airtight plastic sachets
250 ml polyethylene flask
   Balance: Sartorius Signum 1 with a maximum capacity=6.1 kg and with an accuracy of ±0.01 g

### Procedure

96% v/v ethanol originating from VWR Chemicals (CAS: 64-17-5) is diluted with distilled water in order to prepare a volume of 1.5 l of 50% ethanol. 0.78 l of 96% v/v ethanol is thus withdrawn and subsequently made up with a volume of 1.5-0.78 = 0.72 l of distilled water.

This volume is divided in 3 to prepare 3 water/ethanol/polymer solutions.

The density of the polycarbonate is 1.2 g/cm³; consequently, 500 ml of PC correspond to 600 g. The density of the high heat polycarbonate is 1.15 g/cm³; consequently, 500 ml of HH-PC correspond to 575 g.

The water/ethanol mixture, on the one hand, and the polymer, on the other hand, are placed in a reactor (autoclave) at a pressure of 50 bar and then the mixture is heated to reach 260° C. The reaction time varies from 20 to 80 minutes before returning to standard temperature and pressure conditions. The reaction product is then recovered and analyzed.

Preferably, the pressure is chosen so that the water is maintained in the liquid state.

### Results

The chromatographic analyses were carried out according to the standard NF T51-505 (2011): “Plastiques—Résines thermodurcissables—Analyse par chromatographie d'exclusion stérique (G.P.C.)” [Thermosetting Plastics Resins—Analysis by size exclusion chromatography (GPC)].

The following experimental conditions were observed for each sample:
4-column system Polymer Laboratories PIGel, 300×7.5 mm, 5 μm particles, with a porosity of 50 to 105 Å; assembly thermostatically controlled at 40° C.
Eluent filtered analytical grade THF; flow rate 0.5 ml.mn⁻¹.
Prefiltration of the sample through a 0.22 μm PTFE filter.
Double RI (refractive index) and UV (ultraviolet) (254 nm) detection.
Polystyrene calibration; last carried out 2 to 3 months before the measurement.

The weights at the peak Wp, the number-average molecular weights Mn, the weight-average molecular weights Mw (in polystyrene equivalent) and the polydispersity index PI are collated in the following tables 1 to 3.

TABLE 1
Results of the GPC analyses of the PC and HH-PC samples before hydrolysis

| | | Wp (g/mol) | Mn (g/mol) | Mw (g/mol) | PI |
|---|---|---|---|---|---|
| PC-0; 10/1/13 | RI Detection | | | | |
| | 1 | 33 68 | 20 98 | 41 69 | 1.99 |
| | 2 | 8 | 2 | 9 | 1 |
| | 3 | 465 | 558 | 383 | 1.06 |
| | UV Detection | | | | |
| | 1 | 36 83 | 20 62 | 42 91 | 2.08 |
| | 2 | 1 | 7 | 7 | 1 |
| | 3 | 262 | 319 | 303 | 1.03 |
| HH-PC-0; 10/1/13 | RI Detection | | | | |
| | 1 | 35 484 | 16 944 | 40 953 | 2.42 |
| | UV Detection | | | | |
| | 1 | 37 35 | 21 45 | 42 59 | 1.99 |
| | 2 | 7 | 0 | 5 | 1.01 |
| | 3 | 586 | 609 | 617 | 1.02 |

TABLE 2
Results of the GPC analyses of the PC samples after hydrolysis

| | | Wp (g/mol) | Mn (g/mol) | Mw (g/mol) | PI |
|---|---|---|---|---|---|
| PC-20; 09/30/13 | RI Detection | | | | |
| | 1 | 1892 | 2909 | 3239 | 1.11 |
| | 2 | 1653 | 1409 | 1388 | 1 |
| | 3 | 880 | 783 | 775 | 1 |
| | 4 | 380 | 368 | 377 | 1.02 |
| | 5 | 148 | 153 | 154 | 1.01 |
| | UV Detection | | | | |
| | 1 | 2161 | 2920 | 3235 | 1.11 |
| | 2 | 1631 | 1711 | 1573 | 1 |
| | 3 | 1294 | 1337 | 1186 | 1 |
| | 4 | 822 | 788 | 798 | 1.01 |
| | 5 | 381 | 365 | 370 | 1.01 |
| | 6 | 182 | 173 | 175 | 1.01 |
| PC-40; 09/30/13 | RI Detection | | | | |
| | 1 | 2612 | 3883 | 4200 | 1.08 |
| | 2 | 2249 | 1712 | 1755 | 1.02 |
| | 3 | 1129 | 801 | 810 | 1.01 |
| | 4 | 380 | 367 | 373 | 1.02 |
| | 5 | 153 | 157 | 157 | 1 |
| | UV Detection | | | | |
| | 1 | 2586 | 3859 | 4195 | 1.09 |
| | 2 | 2224 | 2300 | 2117 | 1 |
| | 3 | 1712 | 1466 | 1424 | 1 |
| | 4 | 992 | 1018 | 911 | 1 |
| | 5 | 858 | 698 | 677 | 1 |
| | 6 | 382 | 366 | 370 | 1.01 |
| | 7 | 182 | 173 | 177 | 1.02 |
| PC-80; 09/30/13 | RI Detection | | | | |
| | 1 | 1394 | 1888 | 2157 | 1.14 |
| | 2 | 920 | 1098 | 985 | 1 |
| | 3 | 815 | 729 | 716 | 1 |
| | 4 | 376 | 371 | 377 | 1.02 |
| | 5 | 153 | 154 | 155 | 1.01 |
| | UV Detection | | | | |
| | 1 | 1513 | 2263 | 2467 | 1.09 |
| | 2 | 1362 | 1352 | 1245 | 1 |
| | 3 | 981 | 1069 | 936 | 1 |
| | 4 | 794 | 720 | 707 | 1 |
| | 5 | 391 | 373 | 377 | 1.01 |
| | 6 | 181 | 175 | 178 | 1.02 |

TABLE 3
Results of the GPC analyses of the
HH-PC samples after hydrolysis

| | | Wp (g/mol) | Mn (g/mol) | Mw (g/mol) | PI |
|---|---|---|---|---|---|
| HH-PC-20; 09/24/13 | RI Detection | | | | |
| | 1 | 6285 | 3308 | 6049 | 1.83 |
| | 2 | 417 | 385 | 394 | 1.02 |
| | 3 | 142 | 158 | 159 | 1.01 |
| | UV Detection | | | | |
| | 1 | 6338 | 4058 | 6694 | 1.65 |
| | 2 | 1149 | 863 | 861 | 1.00 |
| | 3 | 428 | 394 | 403 | 1.02 |
| | 4 | 153 | 155 | 156 | 1.01 |
| HH-PC-40; 09/24/13 | RI Detection | | | | |
| | 1 | 2701 | 2175 | 3590 | 1.65 |
| | 2 | 427 | 410 | 417 | 1.02 |
| | UV Detection | | | | |
| | 1 | 2523 | 3330 | 4319 | 1.30 |
| | 2 | 1710 | 1484 | 1387 | 1.00 |
| | 3 | 1186 | 1051 | 971 | 1.00 |
| | 4 | 855 | 754 | 708 | 1.00 |
| | 5 | 418 | 438 | 431 | 1.00 |
| | 6 | 335 | 310 | 284 | 1.00 |
| | 7 | 259 | 246 | 222 | 1.00 |
| | 8 | 186 | 169 | 167 | 1.00 |
| HH-PC-80; 09/24/13 | RI Detection | | | | |
| | 1 | 2386 | 3273 | 4182 | 1.28 |
| | 2 | 1760 | 1313 | 1296 | 1.00 |
| | 3 | 926 | 773 | 743 | 1.00 |
| | 4 | 426 | 385 | 398 | 1.03 |
| | 5 | 151 | 156 | 157 | 1.01 |
| | UV Detection | | | | |
| | 1 | 2203 | 3176 | 3829 | 1.21 |
| | 2 | 1600 | 1524 | 1431 | 1.00 |
| | 3 | 1216 | 1122 | 1011 | 1.00 |
| | 4 | 937 | 789 | 759 | 1.00 |
| | 5 | 423 | 385 | 399 | 1.04 |
| | 6 | 169 | 173 | 174 | 1.01 |

### Conclusion

These experiments have shown that the hydrolysis carried out very significantly reduces the average molar masses of the original polymers (0) after a reaction time of only 20 min which are carried out at the reaction conditions used.

For the PC, the reduction in weight is of the order of a division by 10 of the average weights between the original sample and after 20 min. This division of the weights stabilizes between the samples which have undergone hydrolysis for 20, 40 and 80 min.

For the HH-PC, the reduction in weight is slightly less but remains of the order of a division by 5. This division continues to a lesser extent (division by 2) between the sample which has undergone hydrolysis for 20 and 40 min. It stabilizes between the samples which have undergone hydrolysis for 40 and 80 min.

### STAGE 2: PREPARATION OF A HYDROLYSATE POWDER

The dried hydrolysate exists in the form of a pancake (in the case of the PC hydrolyzed for 80 min, the pancake has a weight of approximately 500 grams), the solvents of which have still to finish evaporating. This stage can be carried out by placing in an oven at a mild temperature (at 50° C.) for the time necessary until drying is complete.

The dried pancake is then crushed and subsequently ground using a manual pestle and mortar. The ground material is then sieved in order to obtain a pulverulent system, that is to say a fine powder with a particle size which can be used in a weight metering device of standard type equipped with a screw, for example from 100 to 500 microns.

### STAGE 3: EXTRUSION

The hydrolysate powder and the original PC granules are combined in 2/98 proportions by weight. This mixture is then extruded by a Maris 31 twin-screw corotating extruder (screw diameter 31 mm); the extrusion unit has a gas venting zone at ¾ of the extrusion unit. The flow rate of this extrusion is 12 kg/h. The bulk temperature (at the extrusion head) is 275° C. for PC 2405. The temperature profile is from 20 to 30° C. lower than the injection (250 to 280° C.) in order to reduce the increases in yellow index caused in particular by self-heating or oxidation.

The material is extruded and then cut into the form of rods×3 on a drawing bench. The rods are cooled by passing through a vat of cold water and are then dried with an air knife. The dried rods are then cut up so as to obtain granules, which are placed in bags.

### STAGE 4: TEST OF THE BATCHES MODIFIED BY INJECTION

*Mold for large sheets, T° C. profile from 240 to 290° C., rpm=80, a=40 cm³/s

Measurements of losses in weight by temperature: Table 4

### MFI (Melt Flow Index) Measurements: Table 4

TABLE 4

| Base product | MFI |
|---|---|
| PC 2405 | 19.39 ± 0.70 |
| PC 2405, extruded | 21.89 ± 0.52 |
| PC 2405 + 2% (PCt20) | 28.25 ± 1.09 |
| PC 2405 + 2% (PCt40) | 27.55 ± 1.10 |
| PC 2405 + 2% (PCt80) | 36.06 ± 1.75 |

### Maximum Pressure Measurements: Table 5

TABLE 5

| | Maximum |
|---|---|
| Base product | pressure in bars |
| PC 2405 | 933 ± 12 |
| PC 2405, extruded | 907 ± 4 |
| PC 2405 + 2% (PCt80) | 480 ± 7.5 |

Measurement of Length of Flow (length/thickness or l/t ratio) Postponing the Solidification by Combination of Speed at the Wall: Table 6

The lubrication is generally effected by two measurements on a machine and on a part; these are the falls in pressure for one and the same cavity and the increase in the accessible injectable length, i.e. the l/t ratio, which also indicates a condition of sliding of the material at the metal wall of the mold.

TABLE 6

| Base product | l/t Ratio |
|---|---|
| PC 2405 | 14.3 |
| PC 2405 + 2% (PCt20) | 30.7 |
| PC 2405 + 2% (PCt40) | 31.3 |
| PC 2405 + 2% (PCt80) | 37.7 |

The measurements of E* modulus and the measurements of losses in weight (120° C., 4 days) give statistically indistinct results over all the batches. The yellow index or Yi is 3.34 for PC alone and 4.50 for PC comprising 2% by weight of hydrolysate which has undergone hydrolysis for 80 min (PCt80).

The example above was reproduced for HH-PC under the same conditions and similar results were obtained.

Thus, the flowability of the composition based on the MFI changes from 20 to 36 g/10 min for the PC and from 4 to 8 g/10 min for the HH-PC, this representing an improvement of 100%.

1. An injectable or extrudable polymer composition comprising:
from 90 to 99.9% by weight of a first polymer, and
from 0.1 to 10% by weight of a lubricating compound obtained by partial depolymerization of a polymer,
said percentages being expressed with respect to the total weight of said injectable or extrudable polymer composition, and said polymer from which said lubricating compound is obtained being said first polymer or a polymer of the same nature as said first polymer.

2. The injectable or extrudable polymer composition as claimed in claim 1, in which said first polymer is selected from a group consisting of polycarbonate (PC), polycarbonate/acrylonitrile butadiene styrene (PC-ABS), polyetherimide (PEI) and high-heat polycarbonate (HH-PC).

3. The injectable or extrudable polymer composition as claimed in claim 2, in which said first polymer is polycarbonate or high-heat polycarbonate.

4. The injectable or extrudable polymer composition as claimed in claim 1, in which said lubricating compound is a hydrolysate obtained by hydrolysis of said polymer.

5. The injectable or extrudable as claimed in claim 4, in which said hydrolysis is carried out in the presence of a water/ethanol mixture.

6. The injectable or extrudable polymer composition as claimed in claim 3, in which the average molar mass of said hydrolysate is reduced by a factor ranging from 3 to 20 with respect to that of said first polymer.

7. The injectable or extrudable polymer composition as claimed in claim 1, said injectable or extrudable polymer composition exhibiting an improved viscosity with respect to the flowability of said first polymer.

8. The injectable or extrudable polymer composition as claimed in claim 1 comprising:
from 97 to 99% by weight of said first polymer, and
from 1 to 3% by weight of said lubricating compound,
the percentages being expressed with respect to the total weight of said polymer composition.

9. The injectable or extrudable polymer composition as claimed in claim 1, said injectable or extrudable polymer composition being in a fractionated solid form.

10. A process for the preparation of a polymer composition as claimed in claim 1, said process comprising the following stages:
obtaining said lubricating compound by depolymerization of said polymer,
combining from 10 to 0.1% by weight of said lubricating compound with from 90 to 99.1% by weight of said polymer or of said polymer of the same nature,
the percentages being expressed with respect to said total weight of said polymer composition.

11. The process as claimed in claim 10, in which said polymer and said lubricating compound are, independently of one another, in a fractionated solid form (powder form, compacted granules form) or resin form.

12. An injectable or extrudable composition capable of being obtained by the process as claimed in claim 10.

13. The use of a polymer composition as claimed in claim 1 for the injection molding of a part, preferably of a thin-walled part.

14. A motor vehicle luminous device part obtained by injection into a mold of a polymer composition as claimed in claim 1.

15. The motor vehicle luminous device part as claimed in claim 14, said motor vehicle luminous device part being a shield or a housing.

16. A motor vehicle luminous device comprising said motor vehicle luminous device part as claimed in claim 14.

17. An injection process for obtaining a part as claimed in claim 14, in which use is made of an injection unit comprising a material inlet, an outlet for material toward said mold and means for conveying the material between said material inlet and said outlet for material, said injection process comprising the following stages:
said polymer composition is introduced into said material inlet of said injection unit;
said polymer composition is conveyed in said injection unit; and
a mixture is injected, through said outlet for material of said injection unit, into said mold.

18. The injection process as claimed in claim 17, in which the conveying of said polymer composition in said injection unit is carried out while gradually raising the temperature of said mixture during its displacement in said injection unit.

19. The injection process as claimed in claim 17, in which, before the stage of introduction of said polymer composition into said material inlet of said injection unit, said mixture comprising said polymer composition is prepared.

20. The injectable or extrudable polymer composition as claimed in claim 2, in which said lubricating compound is a hydrolysate obtained by hydrolysis of said polymer.
